(19) United States
(12) Patent Application Publication
(10) Pub. No.: US 2012/0156659 A1
(43) Pub. Date: Jun. 21, 2012

(54) FOREIGN LANGUAGE LEARNING METHOD BASED ON STIMULATION OF LONG-TERM MEMORY

(75) Inventor: Chung-Han YUN, Siheung-si (KR)

(73) Assignee: UNION & EC, INC., Seoul (KR)

(21) Appl. No.: 12/979,574

(22) Filed: Dec. 28, 2010

(30) Foreign Application Priority Data
Dec. 15, 2010 (KR) 10-2010-0128637

(51) Int. Cl. G09B 19/06

(52) U.S. Cl. 434/157

(57) ABSTRACT

Disclosed herein is technology for learning a foreign language based on the stimulation of long-term memory. The foreign language learning method based on the stimulation of long-term memory comprises associative learning which is based on image content and keyword information related thereto, learning which allows a learner to listen to and speak foreign language sentences that comprise keyword information and are related to the image content, learning which allows the learner to repeatedly listen to and speak words constituting a foreign language sentence in such a way as to sequentially add words one by one in a sequence that the words appear in the sentence, and learning which allows the learner to naturally speak sentences with which a specific image is associated when viewing the image, so that the learner habitually memorizes each foreign language sentence or remembers it as one episode, thus providing efficient learning.

### CROSS REFERENCE TO RELATED APPLICATIONS

This application claims the benefit of Korean Patent Application No.10-2010-0128637, filed 2010 Dec. 15, which is hereby incorporated by reference in its entirety into this application.

### BACKGROUND OF THE INVENTION

1. Technical Field

The present invention relates generally to a foreign language learning method and system using a content play device. More particularly, the present invention relates to technology for providing an effective foreign language learning method, which comprises effective learning of a foreign language and enables the results of learning to be remembered for a long period of time by stimulating long-term memory comprising episodic memory and procedural memory.

2. Description of the Related Art

Human memory is composed of short-term memory and long-term memory, Long-term memory comprises episodic memory for remembering personal experiences or the like, semantic memory for remembering knowledge, and procedural memory for remembering the sequence of actions which are memorized by a body. In long-term memory, episodic memory and procedural memory are stronger and remain longer than semantic memory. The reason for this is that episodic memory is generally accompanied by emotion and stimulates brain much stronger, and that procedural memory uses a wider area of the brain.

In foreign language learning methods, typical memorization methods currently use technology based on the five senses such as reading aloud, writing, and repetition. That is, a user memorizes one word or one sentence while continuously and repetitively reading aloud or writing the word or the sentence. This method is effective for the instantaneous short-term memory, but has a problem that it is difficult to transfer the results of learning to long-term memory. Further, such fixed learning methods may tire the brain easily.

Further, since typical memorization methods are applied to an unspecified number of the general public, they are disadvantageous in that differences in the learning styles of different persons required to transfer the results of learning from short-term memory to long-term memory are not taken into account, and thus the disadvantage of such memorization methods being very different from an efficient foreign learning method has been pointed out.

Furthermore, of current foreign language education methods, most education methods stimulate only semantic memory due to public education and private education methods which emphasize writing, reading, etc. Therefore, natural and free education methods such as learning a native language are realistically insufficient, and thus a lot of education methods which are not suitable for the development of actual communicating ability based on a foreign language have been currently used.

### SUMMARY OF THE INVENTION

Accordingly, the present invention has been made keeping in mind the above problems occurring in the prior art, and an object of the present invention is to provide a learning method that allows a foreign language to be learned in a manner similar to that of native language learning methods.

In more detail, another object of the present invention is to provide foreign language learning technology, which allows a learner to effectively acquire foreign language speaking ability, etc, like a native speaker and to remember the details of learning for a long period of time by causing a foreign language to be so stimulative to the learner that it will be as if it had been learned as his or her life on the basis of a foreign language learning method that stimulates episodic memory and procedural memory which belong to long-term memory.

In order to accomplish the above objects, the present invention provides a foreign language learning method by stimulating long-term memory, the method being performed using a content play device and an audio input device which are connected to a learning server over a network, comprising an image mapping learning step which is a learning step of transmitting keyword information corresponding to a video or an image content related to details of learning, or each object image contained in the video or image content, and enabling the keyword information to be associated with the object image, the video content or the image content; a first listening learning step which is a listening learning step of transmitting the video or image content, subtitle content that comprises the keyword information and corresponds to foreign language sentence information related to the video content, the image content or the object image, and audio content that comprises sound information produced when the foreign language sentence information is read aloud; a second listening learning step which is a listening learning step of transmitting the video or image content and the audio content; a first speaking learning step which is a learning step of providing the video or image content, the subtitle content, the audio content, and an audio input and recognition program, and then enabling the foreign language sentence information to be spoken; a second speaking learning step which is a learning step of providing the video or image content, the audio content, and the audio input and recognition program, and then enabling the foreign language sentence information to be spoken; a third speaking learning step which is a learning step of providing the video or image content, the subtitle content, the audio content, and the audio input and recognition program, and enabling a plurality of words constituting the foreign language sentence information to be spoken in such a way as to sequentially add the words one by one onto previous words so that the previous words are repeated, in a sequence that the words appear in the sentence, until the sentence is completed; and an image associative speaking learning step which is a step of providing the video or image content or the object image and hint information to allow a learner to create one or more sentences related to the video or image content or the object image using the hint information, thus allowing the learner to learn a structure of sentences and conduct speaking learning.

The keyword information may be a phrase including one or more words which have meanings corresponding to one or more of a name, a behavior, a shape and a color of the video or image content or the object image.

The hint information may be a phrase including one or more words each having a predetermined meaning.

The foreign language learning method may further include, after the image mapping learning step, a keyword learning step of allowing each keyword to be repeatedly learned so that the keyword is remembered. Preferably, the foreign language learning method may further include, after the second speaking learning step, an interim test step of testing whether the learner has memorized the foreign language sentence information.

The foreign language learning method may further include, after the third speaking learning step, a supplementary speaking learning step of transmitting only the video or image content and the audio content, and then enabling pronunciation, accent and a meaning of the foreign language sentence information to be learned.

The foreign language learning method may further include, after the image associative speaking learning step, a supplementary learning step which is a learning step of providing keyword description information and the keyword audio information, and then enabling the keyword to be associated with the object image, video content or image content corresponding to the keyword, and wherein the keyword description information comprises grammar, a meaning, synonymous phrases, and example sentences which are related to the keyword information, and the keyword audio information is audio information produced when words contained in the keyword information are read aloud.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a foreign language learning method by stimulating long-term memory according to an embodiment of the present invention;

FIGS. 2 to 9 are diagrams showing examples in which the foreign language learning method by stimulating long-term memory is implemented in content according to embodiments of the present invention;

FIG. 10 is a diagram showing the construction of a foreign language learning system by stimulating long-term memory according to an embodiment of the present invention; and

FIG. 11 is a diagram showing an example of the structure of foreign language learning content provided by the present invention.

### DESCRIPTION OF THE PREFERRED EMBODIMENTS

Hereinafter, a foreign language learning method by stimulating long-term memory according to embodiments of the present invention will be described. It should be noted that in the following description, the same reference numerals are used throughout the different drawings to designate the same or similar components or steps.

Further, the embodiments of the present invention will be described based on an English learning method to be provided to learners in non-English speaking countries. However, it is apparent that the present invention can also be applied to all foreign language learning methods, in addition to the English learning method.

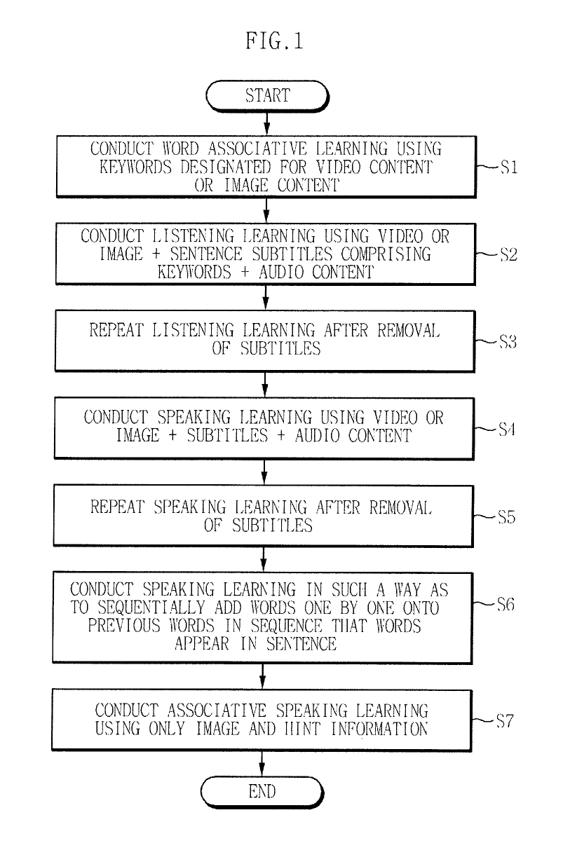

FIG. 1 is a flowchart showing a foreign language learning method by stimulating long-term memory according to an embodiment of the present invention.

Referring to FIG. 1, in the foreign language learning method based by stimulating long-term memory according to the embodiment of the present invention, a first learning step is an image mapping learning step S1.

The image mapping learning step S1 is the learning step at which keywords designated for each piece of video content or image content are provided to a learner, and the learner is capable of associating the provided keywords with corresponding video or image content.

Image mapping, which is a learning method using brain cognitive engineering, is a learning method of stimulating the hippocampus which is the portion of the brain in charge of the memory. In other words, image mapping is a learning method in which a video or an image related to a keyword is used while the keyword is being remembered, so that a video, a picture such as an image, and space which are related to a relevant keyword are remembered, and the keyword is associated with the video, picture and space at the time the keyword is remembered. That is, such image mapping allows a plurality of given keywords to appear to a user like a scene of a film while the user visualizes the actual scene using the keywords.

For example, after the learner sequentially listens to and memorizes four keywords, he or she remembers a sentence related to the keywords while associating the sentence with video content or image content in connection with the video or image content. In this way, the learner may remember the keywords and the video or image content together in episodic memory, and remember words corresponding to the keywords while stimulating long-term memory.

Keywords presented at the image mapping learning step S1 denote information corresponding to the entirety of the video content or image content, or object images contained in the video or image content. This information is designated as keyword information. That is, a content play device provides one or more pieces of video content or image content. In the video or image content, one or more object images can be identified using respective identification numbers. Furthermore, the keyword information together with the video content or the image content can be transmitted to the learner as character information.

The learner memorizes the keyword information and the video or image content together while viewing the video or image content by relating the keyword information with the video or image content, and conducts learning that associates only the keyword information with the entirety of the video or image content or each object image contained in the video or image content.

In the present invention, keyword information may contain the meanings of one or more of the name, behavior, shape and color of the video content, image content or an object image, and may refer to a phrase including one or more words.

For example, it is assumed that video content or image content shows image information about an intersection at a subway station. In the video content or image content including the image information about the intersection at the subway station, a person, a vehicle, the exit of the subway station, etc. may be present as object images. Further, each object image may include specific information, which corresponds to the meanings that can be contained in the keyword information, as described above.

That is, the keyword information may use “subway station” indicating the subway station, “turn on” indicating that the color of a signal is changing, and “traffic jam” indicating that vehicles are blocked due to traffic congestion. In addition, any keyword information can be included in the above keyword information as long as it can be detected from video content or image content and allows the learner to associate it with images.

After step S1 has been completed, a first listening learning step S2 is performed at which the listening learning of the learner is induced by transmitting the video or image content that is provided at step S1, subtitle content that includes foreign language sentence information in which keyword information is included, and audio content that includes sound information produced when the foreign language sentence information is read aloud.

At step S2, foreign language sentence information including keyword information is presented. The foreign language sentence information may preferably be each sentence related to the details of the video content or image content, but is not limited thereto.

An example of English sentence information which uses the keyword information “subway station” presented at step S1 may include “Could you drop me off at the subway station?.” For example, an identification number is assigned to the exit of the subway station which is the object content of the video content or the image content. When there is an action of clicking the identification number or the like, the keyword information and the sentence including the keyword information may be displayed in a lower portion of the video content or the image content in the form of subtitles.

Further, audio content, which is sound information produced when the English sentence information included in the subtitles is read aloud, may be transmitted to the learner. Therefore, the learner is simultaneously provided with the image of the exit of the subway station which is the object image, the keyword information “subway station”, subtitle content in which the sentence “Could you drop me off at the subway station?” is displayed, and sound information produced when a native speaker from the United States or the like reads the sentence aloud, and then learns the provided information.

Step S2 is a first listening learning step at which the learner primarily conducts listening learning while viewing subtitles and listening to audio being read aloud by the native speaker.

Accordingly, in a content management server which manages learning content according to the present invention, character information about a plurality of keywords may match the video content or the image content per the identification information of each object image. The identification information of each object image may include information about the location of video content or image content corresponding to the object image. Further, a plurality of different foreign language sentences that include relevant keyword information may be connected to the keyword information, so that different foreign language sentences may be displayed as subtitles whenever learning is conducted.

Further, audio content which is sound information produced when a native speaker from a corresponding country personally reads aloud a relevant foreign language sentence may be connected to the information about each foreign language sentence. That is, content including the plurality of pieces of information may be connected to each piece of video content or image content to form a single content set, and, consequently, the content set may be stored.

Immediately after step S2, a second listening learning step S3 is performed at which the learning procedure identical to that of step S2 except that only the subtitle content is removed may be conducted. That is, at step S3, only video or image content and audio content are transmitted. Through this procedure, the learner learns foreign language sentences, which were learned while viewing subtitles at the first listening learning step S2, while listening to audio without viewing the subtitles at the second listening learning step. By means of this step, the learner starts to memorize foreign language sentences using procedural memory on the basis of listening-oriented habitual education while gradually becoming habituated to listening to foreign language sentences.

Procedural memory denotes physically habituated memory such as kinesthetic memory. That is, procedural memory refers to memory causing the body of the learner to be habituated to a certain series of procedures through continuous practice. In long-term memory, such procedural memory has been regarded as memory which is difficult to forget, together with episodic memory.

Therefore, the learner continues to practice while listening to and speaking the relevant content without primarily accumulating knowledge of grammar or the like, thus inuring him or herself to a series of procedures related to the foreign language. By means of the series of procedures, a foreign language is retained in the procedural memory together with the above-described episodic memory, thus enabling memory to be more efficiently maintained.

Steps S2 and S3 may form a single procedure, which may be repeated for the number of times desired by the learner or designated by a learning provider. Further, steps S2 and S3 may be repeated until among foreign language sentences including various keywords about all object images, at least one sentence is learned per keyword.

After learning at step S3 has been completed, a first speaking learning step S4 is performed and is a learning step at which an audio input and recognition program is provided in addition to the pieces of content provided at step S2, that is, the video or image content, the subtitle content, and the audio content, thus allowing the learner to speak the foreign language sentence information learned during the above steps.

At the first speaking learning step, the video or image content, the subtitle content and audio content, which were provided to the learner at step S2, are provided. Additionally, a program that can receive the audio of the learner from an audio input device, such as the audio input device of a mobile communication device or the audio input device of a computer, for example, a microphone, and can extract foreign language pronunciation information from the audio of the learner and recognize the foreign language pronunciation information may be provided and executed.

The learner may physically remember the pronunciation of the native speaker learned through the listening learning at steps S2 and S3 while repeating the pronunciation of the native speaker. By means of the learning at step S4, the learner will physically remember a relevant sentence and its correct pronunciation. Therefore, each sentence and its corresponding pronunciation may be retained by the procedural memory and may remain in the long-term memory of the learner.

Immediately after step S4, only subtitle content is removed similarly to step S3. That is, the audio input and recognition program is provided together with the video or image content and the audio content. Accordingly, the learner may experience a second speaking learning step S5 which is the step of conducting speaking learning while the learner repeats sounds, produced when the native speaker reads aloud a relevant sentence, without viewing subtitles.

During steps S4 and S5, the learner efficiently learns each sentence, similarly to steps S2 and S3. Therefore, the learner can learn the sentence while physically practicing the pronunciation of the native speaker.

Similarly to steps S2 and S3, steps S4 and S5 may form a single procedure, which may be repeated for the number of times desired by the learner or designated by a learning provider. Further, step S4 or S5 may be repeated until among foreign language sentences including various keywords about all object images, at least one sentence is learned for each keyword.

After step S5 has been completed, the learner performs a third speaking learning step S6. The third speaking learning step includes the learning of sentence structures and repetitive learning related to the foreign language sentence information which was learned at steps S2 to S4.

In greater detail, as described above, the sentence “Could you drop me off at the subway station?” is assumed. At step S6, the user speaks a plurality of words constituting the sentence in such a way as to sequentially add the words one by one onto the previous words so that the previous words are repeated, in the sequence that the words appear in the sentence, until the sentence is completed. Together with speaking learning, listening learning may be conducted in the same manner as that of the speaking learning.

That is, the learner conducts listening and speaking learning while repeating words constituting the entire sentence “Could you drop me off at the subway station?” in such a way as to sequentially add the words in the sequence of “Could”, “Could you”, “Could you drop”, etc. with the pronunciation of the native speaker until the entire sentence is completed.

Accordingly, the learner may experience a learning procedure of causing the sentence to be naturally formed while sequentially following the words that constitute the sentence on the basis of an initial word with respect to one object image on the theme of the image viewed at the image mapping learning step S1 The learner repeatedly conducts listening and speaking learning while sequentially adding the words of the entire sentence ranging from the initial word to the last word one by one onto the previous words in the sequence that the words appears in the sentence. Therefore, together with this learning, learning about the grammar and the structure of the sentence may also be conducted.

At step S6, the learner may efficiently conduct learning by simultaneously simulating both episodic memory and procedural memory.

After step S6 has been completed, an image associative speaking learning step S7 which is the final step of conducting learning based on one piece of video content or image content is performed. At step S7, the learner learns how to speak his or her desired sentence using direct association with the sentence, in addition to the sentences that have been learned to date.

That is, at step S7, video content, image content or an object image may be provided. In addition to the above information, only hint information may be provided. The hint information refers to a phrase including one or more words each having a meaning in the grammar of the foreign language. Presenting a phrase to be included in the sentence so as to help the user associate an object image, video content or image content with the sentence while the user views the object image or video or image content may be implemented by providing hint information.

For example, it is assumed that an object image in which a driver and a passenger are present in a taxi is presented, and that among various phrases, “subway station” is included as hint information. In this case, the learner can associate the object image including the hint information “subway station” with the sentence while conducting associative learning related to the object image on the basis of the details that have been learned to date. The learner can create the sentence “Could you drop me off at the subway station?” by associating the shape and facial expression of the object image with that sentence.

At step S7, the learner may freely create his or her desired sentences while associating images with the sentences on the basis of the results of the learning at steps S1 to S6. Further, since the learner personally pronounces his or her created sentence using speaking learning, more efficient learning can be conducted.

It is apparent that after learning at step S7 has been completed, learning in a process identical to or different from the above procedure can be repeated using other video content or image content. Further, after step S7 has been terminated, the learner may be provided with the description and audio information of keyword information.

Keyword description information that describes keyword information may include grammar, a meaning, synonymous phrases, and example sentences related to relevant keyword information. That is, the learner primarily and naturally learns keyword information using listening and speaking learning, and then learns the meaning of the keyword information or the like after the keyword information has been used. This is similar to, when a native language is being learned, a procedure for primarily learning a method of using the native language and subsequently learning the detailed meaning and grammar thereof.

Further, the keyword audio information that is audio information obtained when keyword information is spoken contains audio information produced when the words of the keyword information are spoken by the native speaker. Using the keyword audio information, the learner can listen to the correct pronunciation of the keyword information and learn how to speak the keywords.

When the above keyword description information and keyword audio information are provided, the learner may associate the provided information with an object image, video content or image content, which was previously learned with regard to the above provided information, in addition to knowledge contained in the provided information. The above-described learning procedure performed after step S7 is defined as a supplementary learning step.

Further, a keyword learning step may be performed between the image mapping learning step S1 and the first listening learning step S2, and is a step at which the keyword information learned at step S1 is repeatedly learned to be retained in memory. Through this step, the keyword information can be firmly remembered, and familiarity with foreign language sentences including the keyword information can be improved.

An interim test step may be performed between the second speaking learning step S5 and the third speaking learning step S6 and is the step of testing whether the learner has memorized the foreign language sentence information learned at step S5. The learner can proceed to the third speaking learning step S6 only when he or she passes the test. Portions which were insufficiently learned are repeated by means of this test, and thus reliable results of learning can be obtained.

Furthermore, a supplementary speaking learning step may be additionally performed between the third speaking learning step S6 and the image associative speaking learning step S7, and is the step of transmitting only video content or image content and audio content learned at step S6, and then allowing the learner to learn the pronunciation, accent and meaning of the foreign language sentence information. By means of this step, the learner can check a foreign language sentence that he or she has repeated using the speaking learning, and can become aware of the meaning of the sentence.

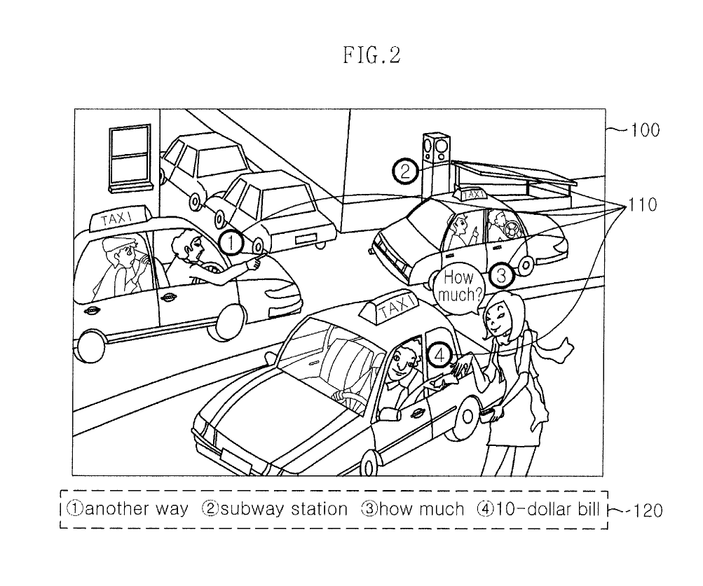

FIGS. 2 to 9 are diagrams showing examples of content in which the foreign language learning method by stimulating long-term memory is implemented according to embodiments of the present invention. The following description is related to an example in which the process of FIG. 1 is implemented. Therefore, a repeated description of the construction identical to that of FIG. 1 will be omitted here.

First, referring to FIG. 2, content at the image mapping learning step SI is presented. In the video content 100 or image content 100 provided at step S1, a plurality of object images that are identified by identification numbers 110 are present.

Any image can be used as an object image as long as it can be represented by words or phrases required for the learning of a foreign language, such as an object, a place or behavior which constitutes the video content 100 or the image content 100. In FIG. 2, a total of four object images are present in the video or image content.

Each object image includes keyword information 120 corresponding thereto. The keyword information 120 may be displayed in a portion of a learning screen. The keyword information 120 refers to all information such as the name, shape or color of the object image or the like, with which the object image can be associated, and includes a phrase each having one or more words.

In FIG. 2, keyword information including the keyword “another way” based on the direction pointed at by a taxi driver, the keyword “subway station” based on the exit of a subway station, the keyword “how much” based on the behavior of a passenger in the taxi, and the keyword “10-dollar bill” based on the noun of ‘money’ is presented.

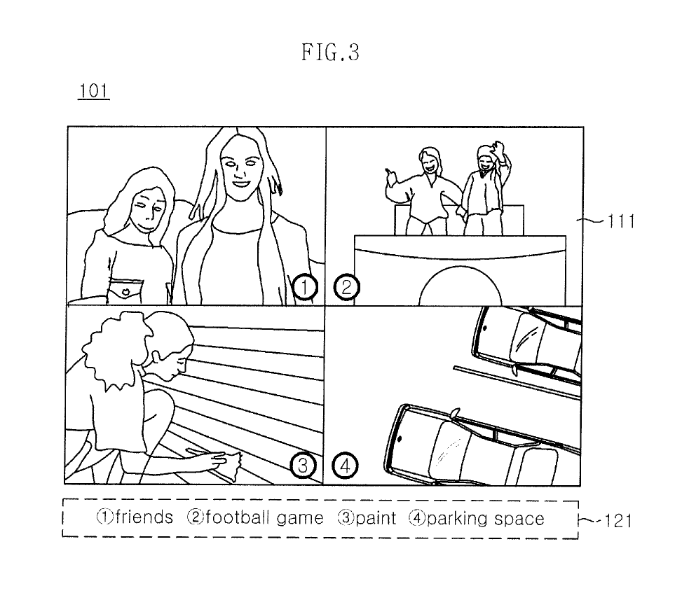

FIG. 3 illustrates another example of image mapping learning. In this example, one screen 101 into which a plurality of pieces of image content are integrated is provided. In this case, one keyword may be provided to each piece of image content 111. That is, a phrase or the like with which each piece of video content 111 or image content 111 can be associated is provided as keyword information 121. For example, the keyword information 121 such as “friends, football game, paint, parking space” may be extracted from each piece of video content 111 or image content 111, and may be provided to the learner.

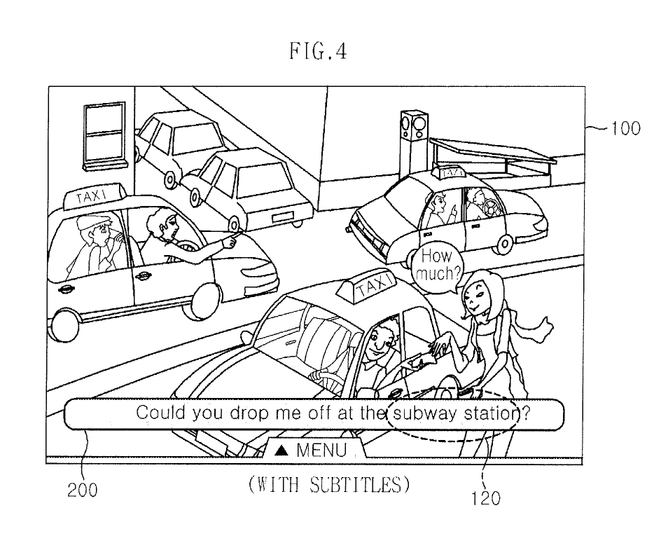

A screen related to the first listening learning step S2 is shown in FIG. 4. Referring to FIG. 4, listening learning for English sentence information that includes the one piece of keyword information “subway station” is conducted.

That is, video content 100 or the image content 100 may be provided on the screen, and subtitle content 200 related to English sentence information including the keyword information 120 may also be provided on a portion of the screen. Together with this subtitle content, audio content which is sound information produced when a native speaker having a standard pronunciation reads aloud the English sentence information is also provided.

Through the provision of the content, the learner may become familiar with a correct pronunciation while learning the video content 100 or image content 100, the subtitle content 200, and the audio content together.

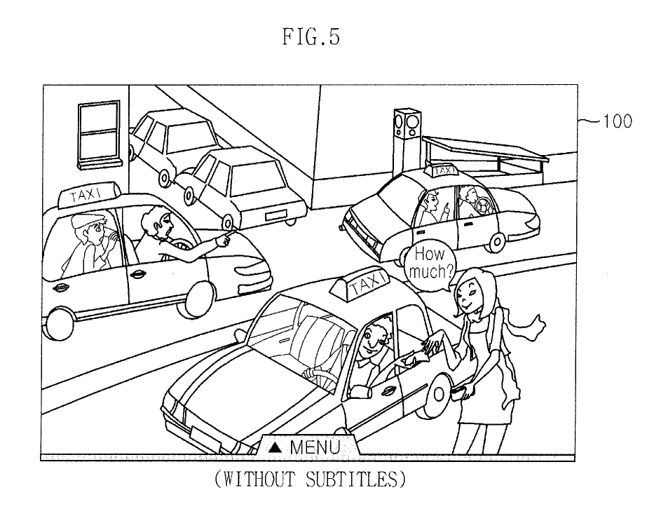

After the first listening learning step S2 of FIG. 4 has been completed, the second listening learning step S3 is performed and is shown in FIG. 5.

Referring to FIG. 5, the screen from which subtitle content 200 was removed may be displayed, unlike FIG. 4. That is, the learner learns English sentences using only audio content and video content 100 or image content 100 without viewing subtitles at the second listening learning step S3.

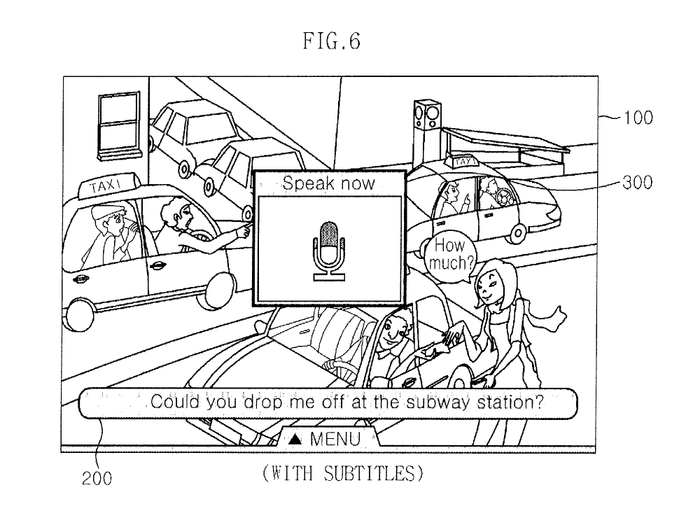

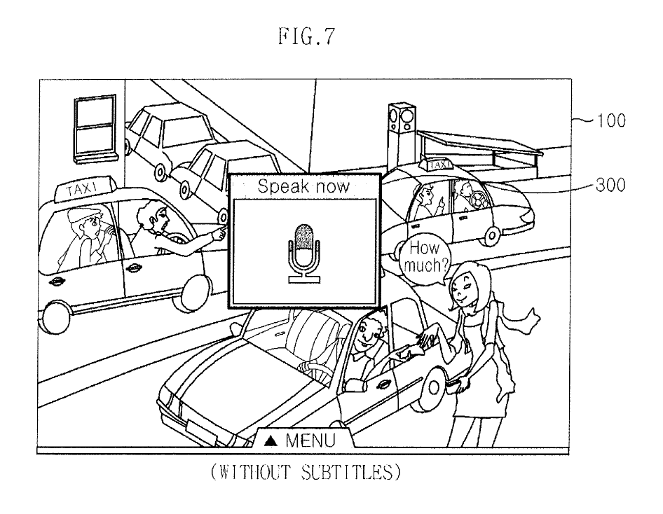

FIGS. 6 and 7 illustrate examples of the screen at the first and second speaking learning steps S4 and S5. At step S4, the learner learns English sentences using video content 100 or image content 100, subtitle content 200, audio content, and an audio input and recognition program 300. At step S5, the learner repeatedly learns English sentences using the video content 100 or image content 100, the audio content, and the audio input and recognition program 300.

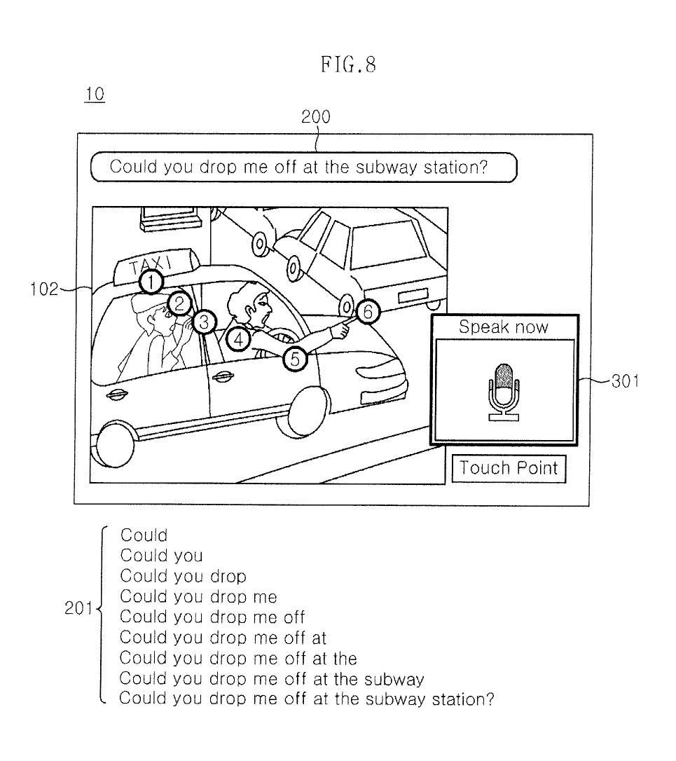

FIG. 8 illustrates an example of the screen at the third speaking learning step S6. In FIG. 8, information 201 in which words constituting a sentence are sequentially added one by one in the sequence that the words appear in the sequence according the structure of the sentence is added in addition to subtitle content 200, an object image 102, audio content, and an audio input and recognition program 201, thus enabling learning at step S6 to be conducted.

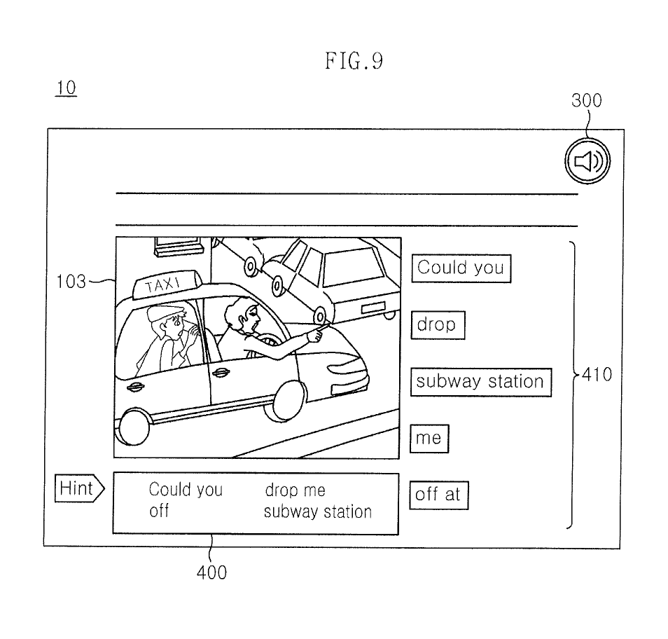

FIG. 9 illustrates the screen at the image associative speaking learning step S7. Referring to FIG. 9, a screen 10 includes audio content and an object image 103, and also includes hint information 410. On the screen 10, a portion 400 denoted by “Hint” indicates an example in which a sentence is formed using the hint information 410.

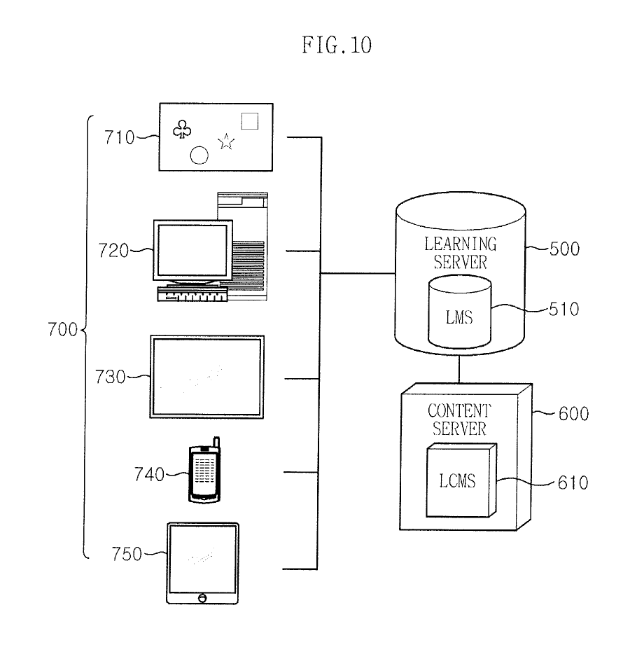

FIG. 10 is a diagram showing the construction of a foreign language learning system by stimulating long-term memory according to an embodiment of the present invention. In the following description, a repeated description of the construction identical to that of FIGS. 1 to 9 will be omitted here.

Referring to FIG. 10, learning apparatuses 700 are implemented. The learning apparatuses 700 may include a woody puzzle 710, a Personal Computer (PC) 720, a Television (TV) 730, mobile communication devices 740 and 750 such as a smart phone and a tablet PC, and the like. The woody puzzle 710 may be operated in conjunction with other learning apparatuses 700 and may be used to provide predetermined input. Further, any device can be used as each learning apparatus 700 as long as it enables video and audio content to be played and audio information to be input.

Further, it is possible to switch to another apparatus and continue to conduct learning while conducting learning using any one of the learning apparatuses 700. That is, as the learner accesses the learning server 500, the learning server 500 continuously stores a series of learning procedures and continuously provides the above-described series of learning procedures to the learner.

For example, when a learner desires to get out of the house while conducting learning using the TV 730 in the house, to access a wireless communication network using the mobile communication device 740 or 750 such as a smart phone or a tablet PC, and to conduct learning over the wireless communication network, the learning server 500 stores and loads the degree of learning progress for each learner in real time, thus allowing the learner to be continuously provided with learning content.

For this operation, the learner can be issued an identification key including an ID and thus can be provided with and use learning procedures and corresponding content by various learning apparatuses 700. Further, the content server 600 may have the function of changing the format of learning content so that one piece of content can be used in various learning apparatuses 700.

The learning server 500 performs the function of enabling the learning procedures described in FIGS. 1 to 9 to be utilized by the learner in conjunction with the learning apparatus 700. The learning server 500 may search the content server 600 for pieces of content corresponding to respective learning procedures, provide the found content, and store learning procedures for respective learners to enable continuous learning services to be provided.

The learner can conduct learning using an apparatus including the learning apparatuses 700, that is, the woody puzzle 710, the PC 720, the TV 730, and the mobile communication devices 740 and 750 such as a smart phone, a tablet PCT and a portable computer, over the network. The results of learning using those various apparatuses may be managed by a Learning Management System 510 in the learning server 500 over the network. Here, the LMS is a system which integrally stores and manages learner information, such as the results of learning of each learner for learning management, the personal information of each learner, and information about the purchase of content, in the server.

Content data that is used to learn using various learning apparatuses 700 is integrally managed by the server via a Learning Content Management System (LCMS) 610 in the content server 600 over the network, so that one piece of content can be implemented by a plurality of various devices, thus enabling the content to be managed via the LCMS so that the revision and upgrade of the content are facilitated.

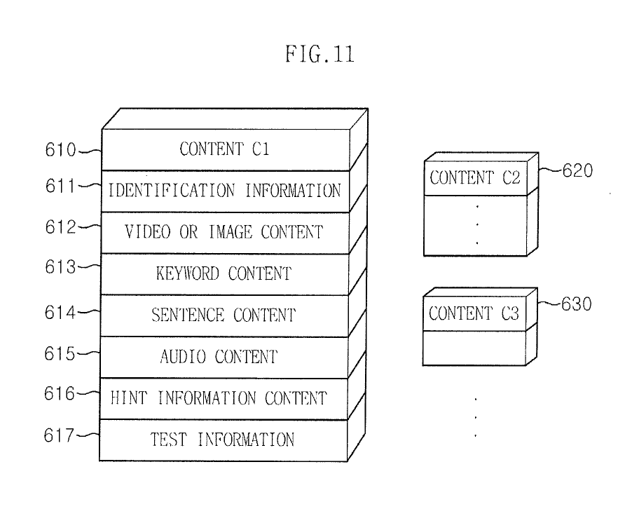

The content server 600 stores various types of information, which can be used by image content based on image content, on an information unit basis, and this will be described in detail in FIG. 11.

FIG. 11 is a diagram showing an example of the structure of foreign language learning content provided according to the present invention.

Referring to FIG. 11, one of the pieces of learning content 610, 620, and 630 may be accessed using identification information 611 about one piece of content.

The content server 600 may store and manage, in addition to the identification information 611, one or more pieces of image content 612, and keyword content 613, sentence content 614, audio content 615, hint information content 616, and test information 617 which respective include keyword information, foreign language sentence information, audio information, hint information, and test information that correspond to the image content, on a content basis.

The description of the foreign language learning method by stimulating long-term memory according to the embodiments of the present invention is not intended to limit the accompanying claims. Further, it is apparent that the embodiments of the present invention and equivalents thereof which perform the same functions as the present invention are also included in the scope of the present invention.

As described above, the present invention has the advantage of a learner experiencing a learning process similar to that of a native language acquisition process via associative learning and repetitive learning which enables repeatedly speaking according to audio, thus allowing the learner to effectively learn a foreign language. Further, in the case of the third speaking learning step, learning is conducted in such a way as to sequentially add words constituting a sentence one by one onto the previous words according to the structure of the sentence. Accordingly, the learner may be habituated to procedures before and after each word when using words, thus naturally learning the grammar, the sentence structure and the words of a foreign language. Therefore, the present invention is advantageous in that it immediately stimulates long-tem memory, that is, episodic memory and procedural memory without undergoing a procedure for changing a foreign language from short-term memory to semantic memory, thus improving learning efficiency.

What is claimed is:

1. A foreign language learning method by stimulating long-term memory, the method being performed by using a content play device and an audio input device which are connected to a learning server over a network, comprising:
an image mapping learning step which is a learning step of transmitting keyword information corresponding to a video or an image content related to details of learning, or each object image contained in the video or image content, and enabling the keyword information to be associated with the object image, the video content or the image content;
a first listening learning step which is a listening learning step of transmitting the video or image content, subtitle content that comprises the keyword information and corresponds to foreign language sentence information related to the video content, the image content or the object image, and audio content that comprises sound information produced when the foreign language sentence information is read aloud;
a second listening learning step which is a listening learning step of transmitting the video or image content and the audio content;
a first speaking learning step which is a learning step of providing the video or image content, the subtitle content, the audio content, and an audio input and recognition program, and then enabling the foreign language sentence information to be spoken;
a second speaking learning step which is a learning step of providing the video or image content, the audio content, and the audio input and recognition program, and then enabling the foreign language sentence information to be spoken;
a third speaking learning step which is a learning step of providing the video or image content, the subtitle content, the audio content, and the audio input and recognition program, and enabling a plurality of words constituting the foreign language sentence information to be spoken in such a way as to sequentially add the words one by one onto previous words so that the previous words are repeated, in a sequence that the words appear in the sentence, until the sentence is completed; and
an image associative speaking learning step which is a step of providing the video or image content or the object image and hint information to allow a learner to create one or more sentences related to the video or image content or the object image using the hint information, thus allowing the learner to learn a structure of sentences and conduct speaking learning.

2. The foreign language learning method of claim 1, wherein the keyword information is a phrase including one or more words which have meanings corresponding to one or more of a name, a behavior, a shape and a color of the video or image content or the object image.

3. The foreign language learning method of claim 1, wherein the hint information is a phrase including one or more words each having a predetermined meaning.

4. The foreign language learning method of claim 1, further comprising, after the image mapping learning step, a keyword learning step of allowing each keyword to be repeatedly learned so that the keyword is remembered.

5. The foreign language learning method of claim 1, further comprising, after the second speaking learning step, an interim test step of testing whether the learner has memorized the foreign language sentence information, the interim test step being configured to sequentially conduct compulsory learning in a learning process.

6. The foreign language learning method of claim 1, further comprising, after the third speaking learning step, a supplementary speaking learning step of transmitting only the video or image content and the audio content, and then enabling pronunciation, accent and a meaning of the foreign language sentence information to be learned.

7. The foreign language learning method of claim 1, further comprising, after the image associative speaking learning step, a supplementary learning step which is a learning step of providing keyword description information and the keyword audio information, and then enabling the keyword to be associated with the object image, video content or image content corresponding to the keyword, and
wherein the keyword description information comprises grammar, a meaning, synonymous phrases, and example sentences which are related to the keyword information, and the keyword audio information is audio information produced when words contained in the keyword information are read aloud.

8. The foreign language learning method of claim I, wherein the foreign language learning method is implemented using an apparatus comprising a woody puzzle, and a personal computer, a portable computer, a television (TV), and a mobile communication device, which enable content to be played and audio information to be input.
